(19) United States
(12) Patent Application Publication
(10) Pub. No.: US 2009/0325501 A1
(43) Pub. Date: Dec. 31, 2009

(54) METHOD AND APPARATUS FOR PRIORITIZING AND REPORTING MULTIPLE WIRELESS COMMUNICATION MEASUREMENT EVENTS

(75) Inventors: Shankar Somasundaram, Deer Park, NY (US); Ulises Olvera-Hernandez, Kirkland (CA); Rajat P. Mukherjee, Stanford, CA (US); Peter S. Wang, East Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/422,456

(22) Filed: Apr. 13, 2009

Related U.S. Application Data
(60) Provisional application No. 61/047,478, filed on Apr. 24, 2008.

(51) Int. Cl. H04B 17/00

(52) U.S. Cl. 455/67.11

(57) ABSTRACT

A wireless transmit/receive unit (WTRU) prioritizes triggered events for the same measurement object to lessen the quantity of events which are included in measurement reports, while conveying no less information. The WTRU triggers an event, starts a time-to-trigger timer for the event, and includes the event in a measurement report. Additionally, where a WTRU measures on multiple frequencies, the event triggering is prioritized according to priorities associated with the frequencies.

### CROSS REFERENCE TO RELATED APPLICATIONS

This application claims the benefit of U.S. Provisional Application No. 61/047,478 filed Apr. 24, 2008, which is incorporated by reference as if fully set forth.

### TECHNICAL FIELD

This application relates to wireless communications.

### BACKGROUND

Wireless systems including third generation partnership project (3GPP) universal mobile telephone system (UMTS), long term evolution (LTE), high-speed packet access (HPSA), HSPA enhancement (HSPA+), and other systems are known. Non-3GPP wireless systems including code division multiple access 2000 (CDMA2000), worldwide interoperability for microwave access (WiMAX), and other systems are also known. 3GPP has initiated the LTE program to bring new technology, new network architecture and configuration, and new applications and services to the wireless cellular network in order to provide improved spectral efficiency, reduced latency, faster user experiences and richer applications and services with less cost. LTE aims at realizing an evolved universal terrestrial radio access network (E-UTRAN).

FIG. 1 shows an LTE network 100 including a serving cell 105 and a neighbor cell 110. The serving cell 105 includes an evolved Node-B (eNode) 120 that serves at least one wireless transmit/receive unit (WTRU) 115. The neighbor cell 110 includes an eNodeB 125. The WTRU 115 is configured to receive a serving cell signal 130 from the eNodeB 120 in the serving cell 105, and to receive a neighbor cell signal 135 from the eNodeB 125 in the neighbor cell 110. In the LTE network 100, the following wireless communication measurement events have been defined for intra-frequency and inter-frequency events:

Event A1: the strength of a serving cell signal 130 becomes better than an absolute threshold;

Event A2: the strength of the serving cell signal 130 becomes worse than an absolute threshold;

Event A3: the strength of a neighbor cell signal 135 becomes an amount of offset better than the serving cell signal 130;

Event A4: the strength of the neighbor cell signal 135 becomes better than an absolute threshold; and

Event A5: the strength of the serving cell signal 130 becomes worse than a first absolute threshold, and the strength of the neighbor cell signal 135 becomes better than a second absolute threshold.

For inter-radio access technology (RAT) configurations, the following wireless communication measurement events have been defined:

Event B1: the strength of the neighbor cell signal 135 becomes better than an absolute threshold; and

Event B2: the strength of the serving cell signal 130 becomes worse than a first absolute threshold, and the strength of the neighbor cell signal 135 becomes better than a second absolute threshold.

These wireless communication measurement events can be configured for any measurement object, (i.e., frequency). Having multiple parallel time-to-trigger timers running for different measurement object configurations may cause problems with measurements for both the WTRU 115 and the LTE network 100.

FIG. 2 shows an example of a case where three measurement objects, (i.e., frequencies), F1, F2 and F3, are being measured in parallel. Five measurement gaps 205₁-205₅, each having a 6 millisecond (ms) length, are necessary to perform sufficient measurements of one measurement object. This implies that, for the case of FIG. 2 where the gap pattern has a gap every 40 ms, 230 ms ((40+6)×5 ms) is necessary to measure one measurement object (e.g., F2). In a simple WTRU implementation, the WTRU measures F1, F2 and F3 serially in a rotated fashion using a single gap pattern. Then, a given measurement object is only measured again after 460 ms. If the time-to-trigger (Ttrig) timer is set to a value of approximately 1.15 seconds, as depicted in FIG. 2, it is doubtful that sufficient measurement samples can be obtained during the time-to-trigger, (i.e., a predetermined time period). If F2 has initiated the time-to-trigger, as depicted in FIG. 2, the WTRU 115 only measures F2 once during the time-to-trigger. In the end, the time-to-trigger expires without any effective check on F2, and a measurement report will be transmitted.

FIG. 2 implies that, unless a better use of gaps is devised, the time-to-trigger loses its expected value. If speed dependent scaling of time-to-trigger is employed, (e.g., if the one second duration is scaled down to half a second), the WTRU 115 may not get any useful measurements.

Rules defined for measurement purposes are desirable such that the problems mentioned above can be overcome.

### SUMMARY

Apparatus and methods for handling of multiple triggered events are disclosed. A WTRU can prioritize triggered events for the same measurement object to lessen the quantity of events which are included in measurement reports, while conveying no less information. Furthermore, the WTRU can trigger an event, start a time-to-trigger timer for the event, and include the event in a measurement report. During the time-to-trigger for this event, no time-to-triggers for other events are started. Additionally, where a WTRU measures on multiple frequencies, the WTRU can prioritize event triggering according to priorities associated with the frequencies.

### BRIEF DESCRIPTION OF THE DRAWINGS

A more detailed understanding may be had from the following description, given by way of example in conjunction with the accompanying drawings wherein:

FIG. 1 shows a conventional LTE system including a serving cell and a neighbor cell;

FIG. 2 shows a timing diagram of multiple measurement objects and measurement gaps;

FIG. 3 is a block diagram of a WTRU; and

FIGS. 4 and 5 are flow diagrams of procedures implemented by the WTRU to prioritize and report wireless communication measurement events.

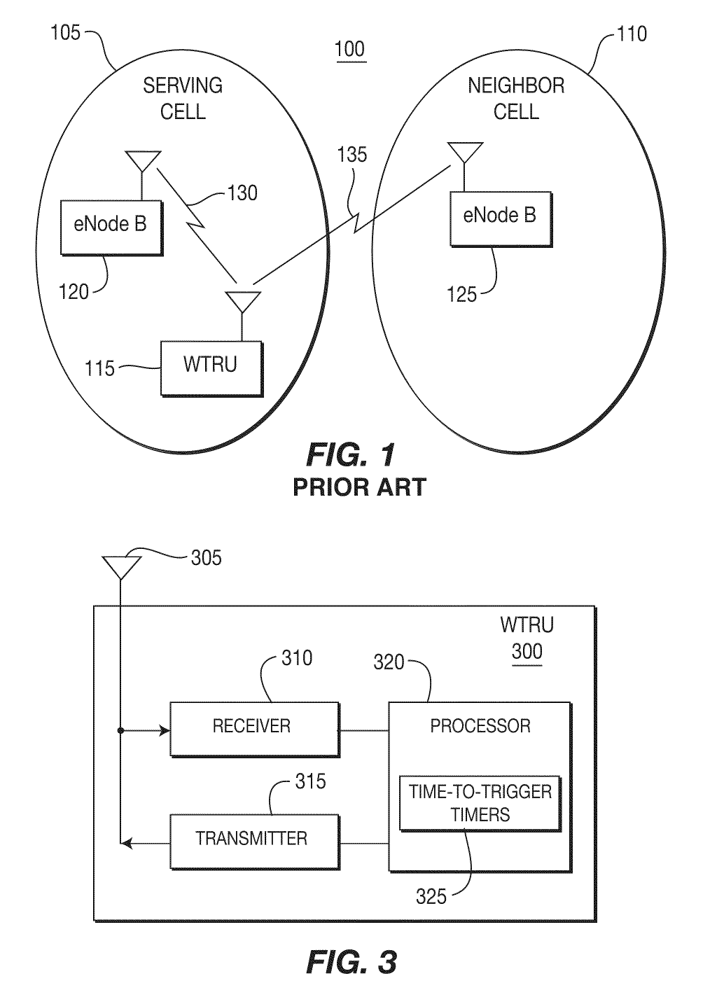

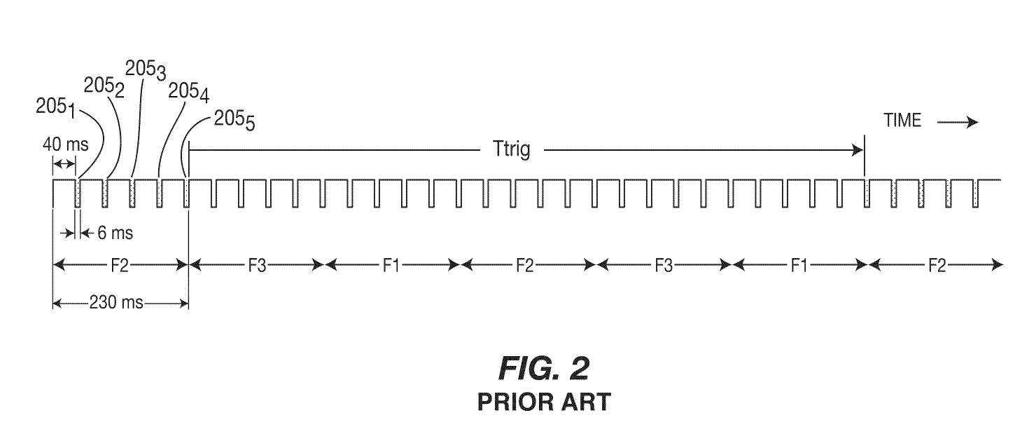

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “evolved Node-B (eNodeB)” includes but is not limited to a base station, a site controller, an access point (AP), or any other type of interfacing device capable of operating in a wireless environment.

A WTRU may handle multiple triggered events by prioritizing wireless communication measurement events for the same measurement object, serving events in the order of the trigger, and defining a frequency order for the different events. FIG. 3 is a block diagram of a WTRU 300 including an antenna 305, a receiver 310, a transmitter 315 and a processor 320 coupled to the receiver 310 and the transmitter 315. Among other features and components, the processor 320 includes a plurality of time-to-trigger timers 325 that may be implemented using either hardware or software, or a combination thereof. The timer-to-trigger timers 325 are used to facilitate various trigger and time-to-trigger functions.

Prioritization Of Wireless Communication Measurement Events For The Same Measurement Object

In LTE, the WTRU 300 can be configured with multiple measurement events for the same measurement object. For example, for a frequency F1, events A1 to A5 are configured for the WTRU 300. Assume a scenario in which the WTRU 300 is camped on a serving cell whose signal strength is decreasing, and there is a neighbor cell whose signal strength is increasing. In such a scenario, event A2, (the strength of the serving cell signal becomes worse than an absolute threshold), may be triggered (i.e., reported) first, followed by event A4, (the strength of the neighbor cell signal becomes better than an absolute threshold), and immediately followed by event A5, (the strength of the serving cell signal 130 becomes worse than a first absolute threshold, and the strength of the neighbor cell signal becomes better than a second absolute threshold).

In this scenario, the WTRU 300 could just report event A5, and effectively provide the same information as conveyed by event A2 and event A4.

For the above example, events can be prioritized by the processor 320 in the WTRU 300, whereby a first event priority order is A5, A3, A2, A1 and A4, and a second event priority order is A5, A2, A3, A1 and A4. Additional event priority orders may also be defined.

When multiple events are triggered, if any high priority event is triggered within X frames, X sub-frames, or X ms of a low priority event, the low priority event time-to-trigger timer 325 should be stopped and the high priority event should be triggered.

Alternatively or additionally, there should be an upper limit (N) on the number of times a low priority event should be stopped to allow for a higher priority event to continue. Thus, in the chain of higher priority events triggered within X ms of a previous lower priority event, only N times the time-to-trigger of the lower priority events are stopped. After N is reached, the lower priority event time-to-trigger is allowed to run concurrently with the higher priority event. Both higher and lower priority events would be reported.

Alternatively or additionally, another limit N1 could be defined which could put an upper limit on the maximum number of time-to-trigger times of events that could run in parallel. For example, if N=2 and N1=2, event A3 could be triggered after N=2 is reached. Then event A5 is triggered, according to N=2, and all of the events A2, A3 and A5 would be allowed to run. However, since N1=2, only two time-to-triggers, (for events A3 and A5), are allowed to run.

For example, using the first event priority order as described above, assume that event A4 is triggered first, and thus its time-to-trigger timer 325 is started. If event A1 is then triggered within X ms of event A4, then the time-to-trigger timer 325 for event A4 would be stopped and the time-to-trigger timer 325 for event A1 would be started. Note that if the event A1 was triggered after X ms of event A4, then the time-to-trigger timer 325 for event A4 would not be stopped, and the time-to-trigger timer 325 for event A1 would also be started.

If event A2 is triggered within X ms of event A1, then the time-to-trigger timer 325 for event A1 would be stopped and the time-to-trigger timer 325 for event A2 may be started.

This example can be developed further by employing an upper limit N on the number of times a lower priority event can be pre-empted. If N=2, then even if another event A3 is triggered within X ms of event A2, the time-to-trigger timer 325 for event A2 would not be stopped. In such a scenario, the time-to-trigger timers 325 for both events A2 and A3 would run in parallel and their events would be triggered.

If N1 is signaled, the WTRU 300 has to ensure that no more than N1 time-to-trigger timers 325 are running. Where the value of N is higher, a higher number of pre-empting of events can be performed.

Also note that the value of X would normally be greater than zero, but could also be equal to zero, in which case the WTRU 300 may decide to select a higher priority event over a low priority one between two events which are triggered at the same time. In the case where X=0, for any higher priority event which is triggered after a low priority event has been triggered, there will be no pre-emption and the time-to-triggers timer 325 for both the high priority event and the low priority event could run in parallel.

Alternatively or additionally, new rules could be defined where the WTRU 300 may change the priority of an event based on the other events which are triggered. For example, in the first event priority order A5, A3, A2, A1 and A4, event A3 has a higher priority than both event A2 and event A4. However, if both events A2 and A4 are triggered, then the WTRU 300 may want to send the reports for events A2 and A4 in place of a report for event A3, since a combination of reports for events A2 and A4 could provide more information. It is important to note that any order for priority of events may be employed.

Additionally, after a measurement report for events is sent out, the WTRU 300 may evaluate the other events and start the time-to-trigger timer 325 for the other events when they meet the condition.

Also note that for the time X for pre-emption, the upper limit N on the number of times a low priority event can pre-empt a higher priority event, and limit the number of time-to-trigger timers 325 that could run in parallel. Furthermore, the priority of the events themselves can each be signaled in system information messages or through radio resource control (RRC) signaling messages, or can be defined by a specification.

Alternatively, the time-to-trigger for each event may be scaled, (e.g., decreased), if more than one event is running in parallel. There may be a limit to the extent to which the time-to-trigger value may be scaled.

Referring to FIG. 3, the WTRU 300 prioritizes and reports wireless communication measurement events. The receiver 310 is configured to obtain a plurality of measurement samples. The transmitter 315 is configured to report a first wireless communication measurement event. The processor 320 is configured to determine wireless communication measurement events based on the measurement samples, determine a priority order for the wireless communication measurement events, and determine whether or not to terminate reporting of any wireless communication measurement event that has a priority that is lower than the first wireless communication measurement event.

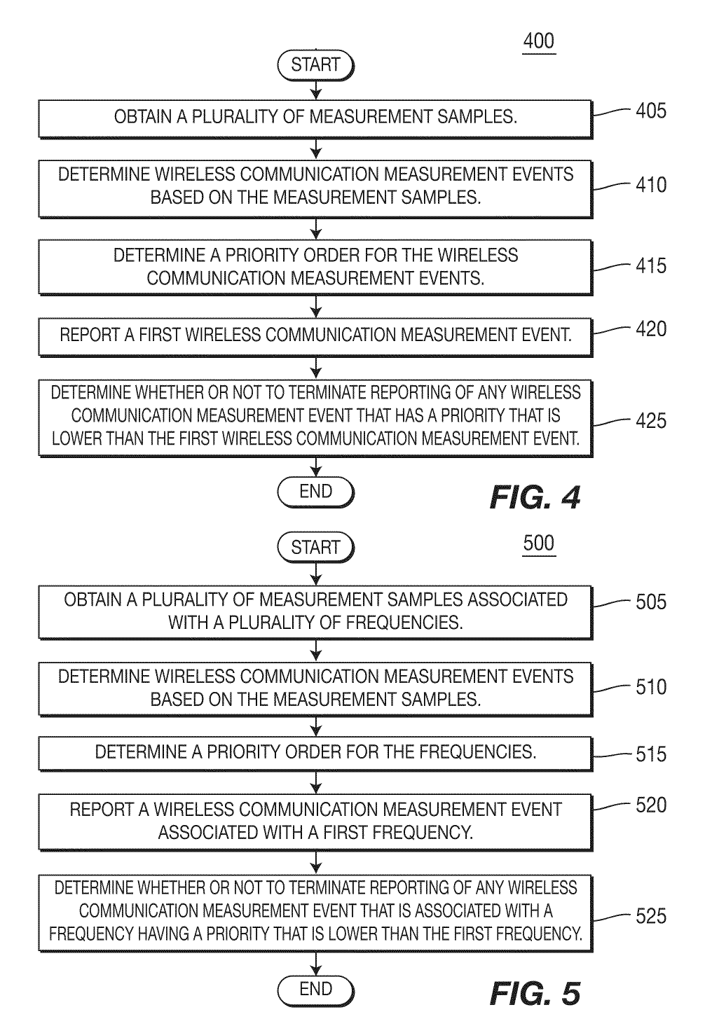

FIG. 4 is a flow diagram of a procedure 400 implemented by the WTRU 300 to prioritize and report wireless communication measurement events. In step 405, the WTRU 300 obtains a plurality of measurement samples. In step 410, the WTRU 300 determines wireless communication measurement events based on the measurement samples. In step 415, the WTRU 300 determines a priority order for the wireless communication measurement events. In step 420, the WTRU 300 reports a first wireless communication measurement event. Finally, in step 425, the WTRU 300 determines whether or not to terminate reporting of any wireless communication measurement event that has a priority that is lower than the first wireless communication measurement event.

Serving Events in the Order of the Trigger

Consider the scenario where the WTRU 300 is configured with multiple measurement events for the same measurement object. For example, for a frequency F1, events A1 to A5 are configured for the WTRU 300. Assume that the WTRU 300 is camped on a serving cell whose signal strength is increasing, and there is a neighbor cell whose signal strength is increasing. In such a scenario, event A2 may be triggered first, followed by event A4 and immediately followed by event A5.

According to the example, the WTRU 300 may serve the time-to-trigger timers 325 in the order in which they are triggered. For example, since the time-to-trigger timer 325 for event A2 is triggered first, the time-to-trigger timer 325 for event A2 will be started first and will not be pre-empted even if any other event is triggered after that.

In this scenario, in the case where multiple events are triggered one after the other, the WTRU 300 would just not start the time-to-trigger timer 325 for the other events till the measurement report for the first event whose time-to-trigger timer 325 is running has been sent.

Alternatively, a minimum interval of X1 frames, X1 sub-frames, or X1 ms may be specified which can be defined as the minimum amount of time that needs to pass before a time-to-trigger timer 325 for a second event is started after the time-to-trigger timer 325 for the first event is started. Accordingly, in the above example, if event A4 is triggered within X ms of event A2, then the time-to-trigger timer 325 for event A4 would not be started. Thus, for the time-to-trigger timer 325 for event A4 to be started, it has to be triggered at least after X ms of A2 having been triggered.

Alternatively or additionally, this may be performed for events which are subsets of one another. For example, events A2 and A4 can be considered a subset of event A5. If the time-to-trigger for event A5 has just been served, within X ms of the time-to-trigger for event A5 ending, the time-to-triggers for events A2 and A4 may not be triggered.

Also, note that interval X1 would normally be greater than zero, but it could also have a value of zero, in which case the time-to-trigger timer 325 for event A4 may be started even if it is triggered immediately after event A2.

Also, an upper limit N may be defined which would define the maximum number of events that could be triggered one after the trigger. The upper limit N may define the maximum number of time-to-trigger timers 325 that could run in parallel.

Once the measurement report for an event is sent out, the WTRU 300 may evaluate the other events and start the time-to-trigger timer 325 for the other events when they meet the condition.

The values X and N may be signaled in system information messages or through RRC signaling messages, or may be defined in the specification.

Defining a Frequency Order for the Different Events

In the case of inter-frequency measurements, the WTRU 300 may be configured with the events A1 to A5 for different frequencies. For example, there may be three frequencies f1, f2 and f3 for which the events may be defined. In such a scenario, the WTRU 300 may want to prioritize between the different frequencies to make sure that the WTRU 300 does not have to trigger too many measurements at the same time.

The concept of signaling priority of frequencies can also be extended to the dedicated mode. In such a case, the priority will be used by the WTRU 300 to determine the frequencies on which it needs to do measurements on and/or start the triggering, while not necessarily for handover purposes.

When the cells of a frequency with a higher priority are being triggered for sending a measurement report, the WTRU 300 would automatically not start the trigger or do the measurements on the lower priority frequencies.

Alternatively, the WTRU 300 may have implicit rules for deciding the priority of frequencies based on the signal strength. For example, a parameter Fₜₕᵣₑₛₕ may be used. The frequency whose signal strength measurement/quality measurement exceeds the value of Fₜₕᵣₑₛₕ will be taken as highest priority, and the cells of the other frequencies will be taken as lower priority for triggering. Alternatively, a number of Fₜₕᵣₑₛₕ parameters could be signaled by the LTE network which will help the WTRU 300 decide the priority of frequencies.

Note that any other implicit rule for prioritizing the frequencies over one another for measurement purposes or triggering events may also be used.

Alternatively, a first-come first-served order may also be used, wherein the WTRU 300 only measures or triggers frequencies in the order in which it is able to detect them.

Alternatively or additionally, a value N may be defined which would define the maximum number of frequencies that may be measured in parallel, or the maximum number of frequencies on which triggering of an event may be performed. The WTRU 300 may then use one of the priority rules mentioned above to determine the exact frequencies on which parallel measurement/triggering of events may be performed.

Alternatively or additionally, a value X, (frames/sub-frames/ms), may be specified, which may be defined as the minimum amount of time that needs to be satisfied before measurements on a second frequency are started after measurements for the first frequency are started. Alternatively or additionally, the value X may be specified as the minimum amount of time needed before a time-to-trigger timer 325 for a cell of the second frequency is started, and after a time-to-trigger timer 325 for a cell of the first frequency is started.

Also note that the value X would normally be greater than zero but it could also have a value of zero, in which case the measurements or triggering on a second frequency could be started even if it is detected immediately after the measurements or triggering on the first frequency is started.

Also note that the values Fₜₕᵣₑₛₕ, N, X and the priority event order may be signaled by the network through system information messages or through dedicated RRC signaling, or it could be defined in the specification.

The above-described approaches for event prioritization, serving event trigger, and event frequency order may be used in alone or in any combination or sub-combination.

Referring again to FIG. 3, the WTRU 300 prioritizes and reports wireless communication measurement events. The receiver 310 is configured to obtain a plurality of measurement samples associated with a plurality of frequencies. The transmitter 315 is configured to report a wireless communication measurement event associated with a first frequency. The processor 320 is configured to determine wireless communication measurement events based on the measurement samples, determine a priority order for the frequencies, and determine whether or not to terminate reporting of any wireless communication measurement event that is associated with a frequency having a priority that is lower than the first frequency.

FIG. 5 is a flow diagram of a procedure 500 implemented by the WTRU 300 to prioritize and report wireless communication measurement events. In step 505, the WTRU 300 obtains a plurality of measurement samples associated with a plurality of frequencies. In step 510, the WTRU 300 determines wireless communication measurement events based on the measurement samples. In step 515, the WTRU 300 determines a priority order for the frequencies. In step 520, the WTRU 300 reports a wireless communication measurement event associated with a first frequency. Finally, in step 525, the WTRU 300 determines whether or not to terminate reporting of any wireless communication measurement event that is associated with a frequency having a priority that is lower than the first frequency.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method implemented by a wireless transmit/receive unit (WTRU) for prioritizing and reporting wireless communication measurement events, the method comprising:
obtaining a plurality of measurement samples;
determining wireless communication measurement events based on the measurement samples;
determining a priority order for the wireless communication measurement events;
reporting a first wireless communication measurement event; and
determining whether or not to terminate reporting of any wireless communication measurement event that has a priority that is lower than the first wireless communication measurement event.

2. The method of claim 1 wherein the determination of whether or not to terminate reporting is based on whether a wireless communication measurement event falls within a predetermined time period during which the first wireless communication measurement event is to be reported.

3. The method of claim 1 wherein a wireless communication measurement event is not terminated if it has been previously terminated a predetermined number of times.

4. The method of claim 1 wherein the wireless communication measurement events include a serving cell signal strength becoming better than an absolute threshold.

5. The method of claim 1 wherein the wireless communication measurement events include a serving cell signal strength becoming worse than an absolute threshold.

6. The method of claim 1 wherein the wireless communication measurement events include a neighbor cell signal strength becoming an amount of offset better than a serving cell signal strength.

7. The method of claim 1 wherein the wireless communication measurement events include a neighbor cell signal strength becoming better than an absolute threshold.

8. The method of claim 1 wherein the wireless communication measurement events include a serving cell signal strength becoming worse than a first absolute threshold and a neighbor cell signal strength becoming better than a second absolute threshold.

9. The method of claim 1 wherein the wireless communication measurement events include a neighbor cell signal strength becoming better than an absolute threshold.

10. The method of claim 1 wherein the wireless communication measurement events include a serving cell signal strength becomes worse than a first absolute threshold and a neighbor cell signal strength becomes better than a second absolute threshold.

11. A method implemented by a wireless transmit/receive unit (WTRU) for prioritizing and reporting wireless communication measurement events, the method comprising:
obtaining a plurality of measurement samples associated with a plurality of frequencies;
determining wireless communication measurement events based on the measurement samples;
determining a priority order for the frequencies;
reporting a wireless communication measurement event associated with a first frequency; and
determining whether or not to terminate reporting of any wireless communication measurement event that is associated with a frequency having a priority that is lower than the first frequency.

12. The method of claim 11 wherein the priority of the frequencies is determined based on at least one of signal strength or quality.

13. A wireless transmit/receive unit (WTRU) for prioritizing and reporting wireless communication measurement events, the WTRU comprising:
a receiver configured to obtain a plurality of measurement samples;
a transmitter configured to report a first wireless communication measurement; and
a processor configured to determine wireless communication measurement events based on the measurement samples, determine a priority order for the wireless communication measurement events, and determine whether or not to terminate reporting of any wireless communication measurement event that has a priority that is lower than the first wireless communication measurement event.

14. The WTRU of claim 13 wherein the processor determines of whether or not to terminate reporting based on whether a wireless communication measurement event falls within a predetermined time period during which the first wireless communication measurement event is to be reported.

15. The WTRU of claim 13 wherein a wireless communication measurement event is not terminated if it has been previously terminated a predetermined number of times.

16. The WTRU of claim 13 wherein the wireless communication measurement events include a serving cell signal strength becoming better than an absolute threshold.

17. The WTRU of claim 13 wherein the wireless communication measurement events include a serving cell signal strength becoming worse than an absolute threshold.

18. The WTRU of claim 13 wherein the wireless communication measurement events include a neighbor cell signal strength becoming an amount of offset better than a serving cell signal strength.

19. The WTRU of claim 13 wherein the wireless communication measurement events include a neighbor cell signal strength becoming better than an absolute threshold.

20. The WTRU of claim 13 wherein the wireless communication measurement events include a serving cell signal strength becoming worse than a first absolute threshold and a neighbor cell signal strength becoming better than a second absolute threshold.

21. The WTRU of claim 13 wherein the wireless communication measurement events include a neighbor cell signal strength becoming better than an absolute threshold.

22. The WTRU of claim 13 wherein the wireless communication measurement events include a serving cell signal strength becomes worse than a first absolute threshold and a neighbor cell signal strength becomes better than a second absolute threshold.

23. A wireless transmit/receive unit (WTRU) for prioritizing and reporting wireless communication measurement events, the WTRU comprising:
a receiver configured to obtain a plurality of measurement samples associated with a plurality of frequencies;
a transmitter configured to report a wireless communication measurement event associated with a first frequency; and
a processor configured to determine wireless communication measurement events based on the measurement samples, determine a priority order for the frequencies, and determine whether or not to terminate reporting of any wireless communication measurement event that is associated with a frequency having a priority that is lower than the first frequency.
